(19) United States
(12) Patent Application Publication
(10) Pub. No.: US 2014/0206292 A1
(43) Pub. Date: Jul. 24, 2014

(54) ELECTRONIC SHELF LABEL SYSTEM

(71) Applicant: SiPix Technology Inc., Taoyuan County (TW)

(72) Inventors: Chi-Mao Hung, Taoyuan County (TW); Wei-Min Sun, Taoyuan County (TW); Chih-Yuan Hsu, Taoyuan County (TW)

(73) Assignee: SiPix Technology Inc, Taoyuan County (TW)

(21) Appl. No.: 14/151,825

(22) Filed: Jan. 10, 2014

(30) Foreign Application Priority Data
Jan. 18, 2013 (TW) 102102051

(51) Int. Cl. H04B 7/24

(52) U.S. Cl. CPC H04B 7/24
USPC 455/66.1

(57) ABSTRACT

An electronic shelf label (ESL) system is disclosed. The ESL system includes a shelf, at least an ESL, and a radio-frequency (RF) signal transceiver. The ESL is disposed on the shelf. The ESL includes a RF antenna, and the RF antenna defines a signal transmitting H-plane. The RF signal transceiver transceives data with the ESL through the RF antenna, wherein, a connection line between the RF signal transceiver and the RF antenna has an included angle smaller than a pre-determined angle with the signal transmitting H-plane of the RF antenna.

### CROSS-REFERENCE TO RELATED APPLICATION

This application claims the priority benefit of Taiwan application serial no. 102102051, filed on Jan. 18, 2013. The entirety of the above-mentioned patent application is hereby incorporated by reference herein and made a part of this specification.

### BACKGROUND OF THE INVENTION

1. Field of the Invention

The present invention is related to an electronic shelf label (ESL) system. More particularly, to an ESL system to transceive data through a radio-frequency (RF) signal.

2. Description of Related Art

In the conventional technical field, an electro-phoretic display (EPD) is provided as an application to the electronic shelf label (ESL). In which, a data transmission with a radio-frequency (RF) transceiver is performed on the ESL through a RF signal. A plurality of RF signal transceivers being disposed may be utilized by a shelf administrator to manage the corresponding ESLs.

However, various noises are usually existed in a storage region (e.g., a store) of products so a signal and noise ratio (SNR) of the RF signal for the data transmission between the ESL and the RF signal transceiver is relatively low, which may result the data transmission between the ESL and the RF signal transceiver being performed incorrectly.

Referring to FIG. 4, FIG. 4 is a schematic view illustrating a transmission between an ESL and a card reader. In a case where an angle between an extending direction HDP of a signal transmitting H-plane of a RF antenna on an ESL 410 and a signal transceiver 420 for receiving signals being too great, a bad signal transmission between the signal transceiver 420 and the ESL 410 may occur.

### SUMMARY OF THE INVENTION

The present invention is directed to an ESL system to effectively increase an efficiency in transceiving data between a RF signal transceiver and the ESL.

An electronic shelf label (ESL) system of the invention includes a shelf, at least one ESL, and a radio-frequency (RF) signal transceiver. The ESL is disposed on the shelf The ESL includes a RF antenna, and the RF antenna defines a signal transmitting H-plane. The RF signal transceiver transceives data with the ESL through the RF antenna, wherein, a connection line between the RF signal transceiver and the RF antenna has an included angle smaller than a pre-determined angle with the signal transmitting H-plane of the RF antenna.

In one embodiment of the invention, the ESL further includes a RF signal processing chip. The RF processing chip is coupled to the RD antenna and receives or transmits at least one RF data through the RF antenna.

According to an embodiment of the invention, the RF antenna is an on-chip RF antenna.

According to an embodiment of the invention, the shelf has an upper surface and at least one display plane, the display plane is extended to intersect with the upper surface, the upper surface is located at a relatively upper position of the display plane, the ESL is disposed on the display plane, and the RF signal transceiver is disposed on the upper surface of the shelf

According to the embodiment of the invention, the display plane is intersected with a vertical extension of the upper surface.

According to the present embodiment of the invention, the RF antenna is further defined with a signal transmitting E-plane, the signal transmitting H-plane is vertically intersected with the signal transmitting E-plane. The RF antenna has a first signal strength on the signal transmitting H-plane and a second signal strength on the signal transmitting E-plane, and the first signal strength is greater than the second signal strength.

Based on above, the embodiments of the invention provides one or more ESLs to be disposed on the shelf, and a RF signal transceiver is also disposed to transceiving data with the signal transmitting H-plane of the RF antenna of the ESL for data transmission. Accordingly, the data transmission between the RF signal transceiver and the ESL may be more reliable, so as to improve an efficiency of the whole system.

To make the above features and advantages of the invention more comprehensible, several embodiments accompanied with drawings are described in detail as follows.

### BRIEF DESCRIPTION OF THE DRAWINGS

FIG. 1 is a schematic view illustrating an electronic shelf label (ESL) 100 according to an embodiment of the invention.

FIG. 2A to FIG. 2D respectively illustrate different signal transmitting planes of an ESL 131 and distribution diagrams of signal energy thereof.

FIG. 3 is an implementation of the ESL 131 according to an embodiment of the invention.

FIG. 4 is a schematic view illustrating a transmission between an ESL and a card reader.

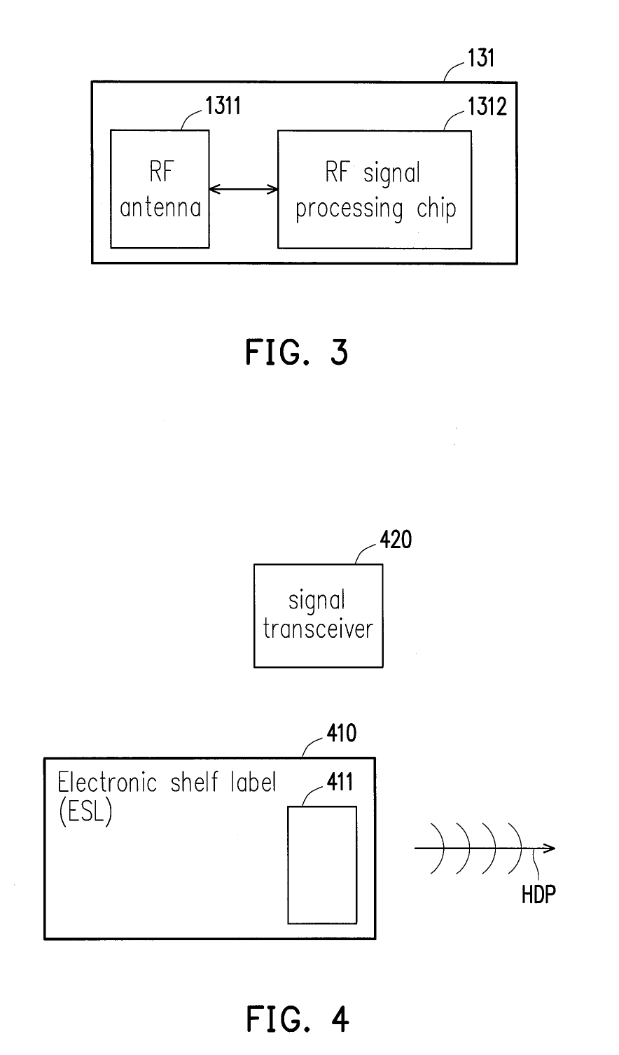

### DESCRIPTION OF THE EMBODIMENTS

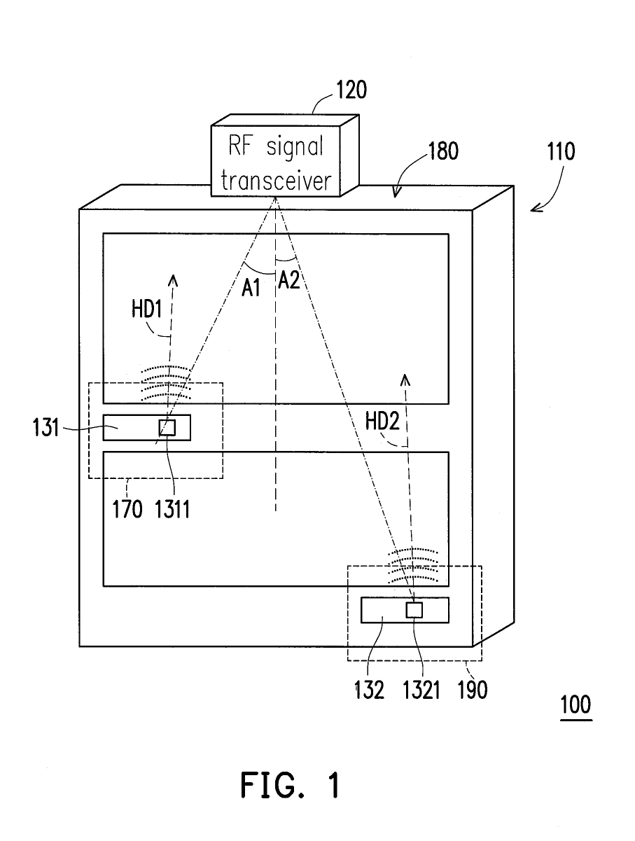

Referring to FIG. 1, FIG. 1 is a schematic view illustrating an electronic shelf label (ESL) 100 according to an embodiment of the invention. The ESL system 100 includes a shelf 110, ESLs 131 and 132, and a radio-frequency (RF) signal transceiver 120. The ESLs 131 and 132 are disposed on the shelf 110, RF antennas 1311 and 1321 are respectively disposed on the ESLs 131 and 132. In addition, the RF signal transceiver 120 transceives data with the ESLs 131 and 132 respectively through the RF antenna 1311 and the RF antenna 1321. In which, a connection line of the RF signal transceiver 120 and the a RF antenna 1311 of the ESL 131 has an included angle A1 smaller than a pre-determined angle with an extending direction HD1 of a signal transmitting H-plane of the antenna 1311. Further, a connection line of the RF signal transceiver 120 and the a RF antenna 1321 of the ESL 132 also has an included angle A2 smaller than the pre-determined angle with an extending direction HD2 of the signal transmitting H-plane of the antenna 1321. In which, the extending directions HD1 and HD2 may not be parallel to one another.

In other words, in the present embodiment, when the ESLs 131 and 132 utilize the RF antennas 1311 and 1321 disposed thereto to transceive data with the RF signal transceiver 120, a RF signal received by the RF signal transceiver 120 is received from a location closest to the signal transmitting H-plane in each of the RF antennas 1311 and 1321. Relatively, when the ESLs 131 and 132 utilize the RF antennas 1311 and 1321 disposed thereto to receive a RF data transmitted from the RF signal transceiver 120, the RF signal transmitted by the RF signal transceiver 120 is received from the location closest to the data transmitting H-plane in the RF antennas 1311 and 1321.

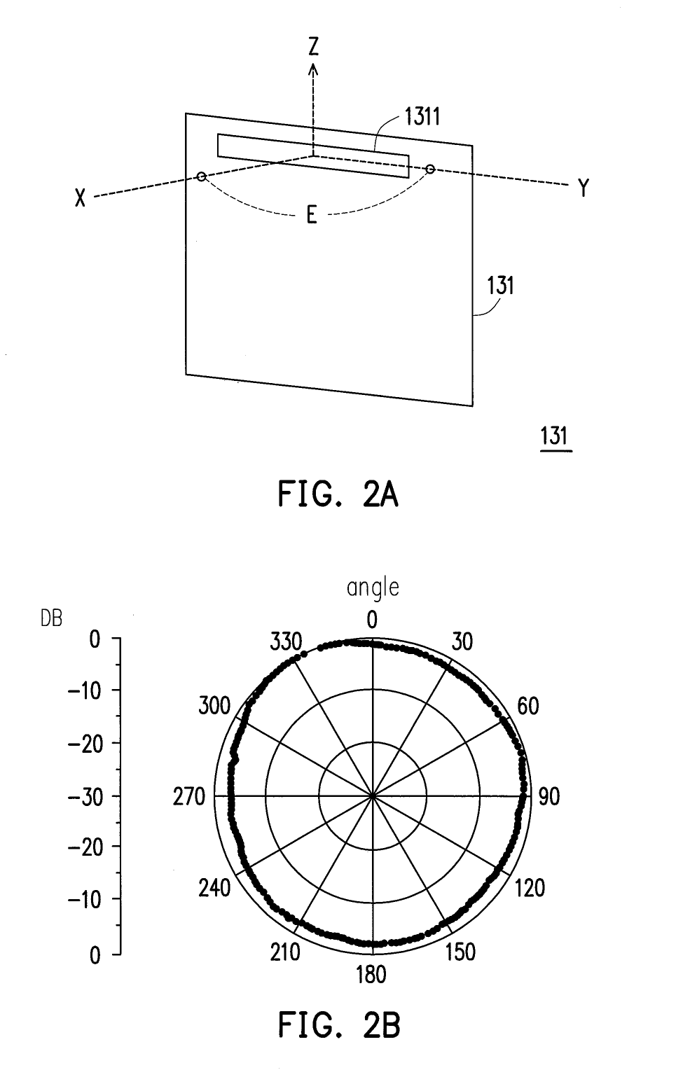

FIG. 2A to FIG. 2D respectively illustrate various signal transmitting planes of an ESL 131 and distribution diagrams of signal energy thereof. Referring to FIG. 2A, three axises (respectively being a X-axis, a Y-axis and a Z-axis) are defined based on a location of the RF antenna 1311 disposed on the ESL 131. In which, a plane defined by the Z-axis and the X-axis is known as the signal transmitting H-plane of the RF antenna 1311. According to FIG. 2B, it is apparent that an energy of the RF signal transmitted by the RF antenna 1311 (which is then received by the signal transmitting H-plane of the RF antenna 1311) is homogeneously maintained at a high energy state in different angles.

Relatively in FIG. 2C, a X-axis, a Y-axis and a Z-axis are defined by a location of the RF antenna 1311 disposed on the ESL 131. In which a plane defined by the X-axis and the Y-axis is known as a signal transmitting E-plane of the RF antenna 1311. According to FIG. 2D, it is apparent that an energy of the RF signal transmitted by the RF antenna 1311 (which is then received by the signal transmitting E-plane of the RF antenna 1311) has great variations in different angles. Also, in most of the receiving angles, the energy of the RF signal received can not reach its maximum energy value.

Referring back to FIG. 1 with reference of FIG. 2A to FIG. 2D, in the case where connection lines to the ESLs 131 and 132 disposed on the signal transceiver respectively has an included angle smaller than a pre-determined angle with the signal transmitting H-plane of the antennas 1311 and 1322, when the RF signal is transceived between the RF signal transceiver and the ESLs 131 and 132, an effective transmission energy of the RF signal may be increased thereby increasing the SNR of the RF signal transmission. As a result, a transmission efficiency between the RF signal transceiver 120 and the ESLs 131 and 132 may be effectively improved.

Said pre-determined angle may be determined by a system administrator based on noises that might be generated by a site environment. More specifically, in a case when the site environment is capable of generating noises with a greater energy, the pre-determined angle may be set to a smaller value. Relatively, in a case when the site environment is capable of generating noises with a smaller energy, the pre-determined angle may be set to a greater value. In general, the pre-determined angle is better less than 45 degrees.

Moreover, according to the present embodiment, the ESLs 131 and 132 are respectively disposed on display planes 170 and 190 on the shelf 110. In addition, the shelf 110 has an upper surface 180, and the RF signal transceiver 120 is disposed on the upper surface 180. In which, the upper surface 180 of the shelf 110 is located at a relatively upper position of the display planes 170 and 190. According to the embodiment of the invention, the display planes 170 and 190 are intersected with a vertical extension of the upper surface 180.

In addition, a number of the ESLs (e.g., 131 and 132) disposed on the shelf 110 is not necessary to be two. In which, the embodiment of the ESL 131 and 132 as illustrated in FIG. 1 is merely an example, a user may dispose one or more ESL based on actual requirements.

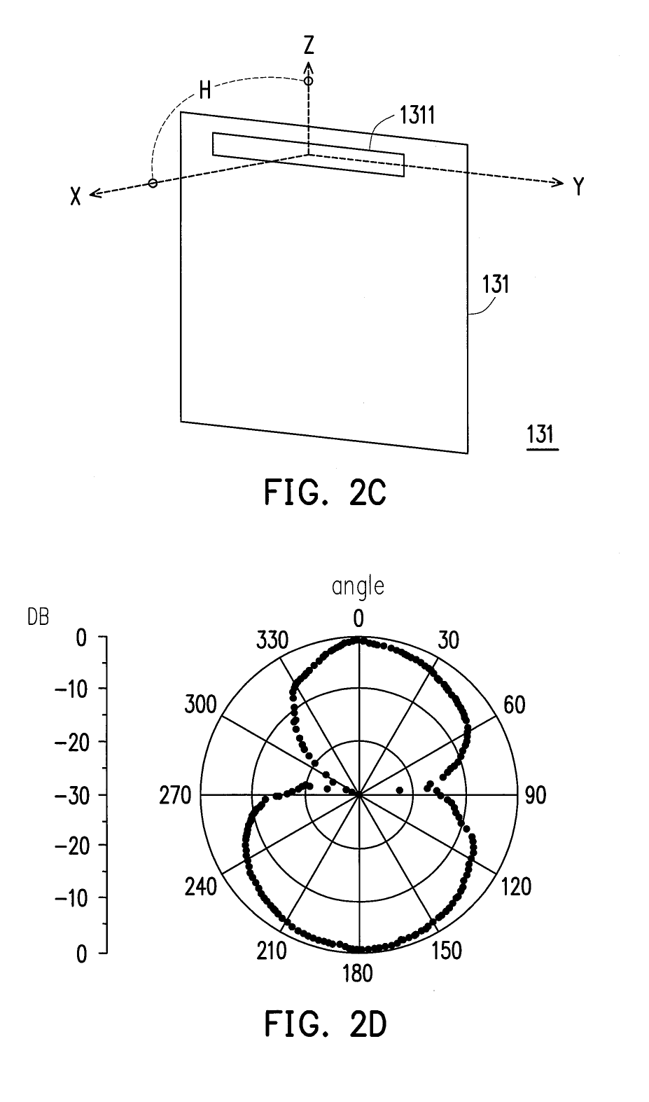

Referring to FIG. 3, FIG. 3 is an implementation of the ESL 131 according to an embodiment of the invention. In which, the ESL 131 includes the RF antenna 1311 and a RF signal processing chip 1312, the RF antenna 1311 and the RF signal are coupled to one another. The RF signal processing chip 1312 may transmit the RF signal through the RF antenna 1311. Relatively, the RF signal processing chip 1312 may also receive the RF signal transmitted from the outside through the RF antenna 1311.

In addition, after the RF signal from the outside is received by the RF antenna 1311 of the RF signal processing chip 1312, one or more data may be obtained according to the RF signal being received, so as to change a product information to be displayed on the electro-phoretic display on the ESL 131. Said product information includes information such as a product price, a manufacturing date and expiration date.

The RF antenna 1311 may be an on-chip RF antenna. In other words, the RF antenna 1311 may be constructed by using a layout of metal lines (or other transmitting lines) on a chip. For instance, the on-chip RF antenna 1311 may be implemented by disposing and surrounding one or many metal lines to each other in one or many metal layers. Detailed description to the layout of the on-chip RF antenna belongs to a technology well-known by person skilled in the art, so it is omitted hereinafter.

In the case when the RF antenna 1311 is the on-chip RF antenna, a structure of system on chip (SOC) may be realized by having the RF antenna 1311 and the RF signal processing chip 1312 disposed on the same chip. Accordingly, costs for manufacturing the ESL 131 may be further reduced, so as to enhance the competitiveness of the whole system.

In view of above, the embodiments of the invention provides a connection line between the RF signal transceiver and the RF antenna having the included angle smaller than the pre-determined angle with the signal transmitting H-plane, which may increase the effective transmission energy of the RF signal transmitted between the RF signal transceiver and the ESL, thereby increasing the SNR of the RF signal transmission to improve reliability of the data transmission of the ESL.

What is claimed is:

1. An electronic shelf label (ESL) system, comprising:
a shelf;
at least one ESL disposed on the shelf, the ESL having a radio-frequency (RF) antenna to define a signal transmitting H-plane;
a RF signal transceiver transceiving data with the ESL through the RF antenna, wherein a connection line between the RF signal transceiver and the RF antenna has an included angle smaller than a pre-determined angle with the signal transmitting H-plane of the RF antenna.

2. The ESL system of claim 1, wherein the ESL further comprises:
a RF processing chip coupled to the RD antenna and receiving or transmitting at least one RF data through the RF antenna.

3. The ESL system of claim 1, wherein the RF antenna is an on-chip RF antenna.

4. The ESL of claim 1, wherein the shelf has an upper surface and at least one display plane, the display plane is extended to intersect with the upper surface, the upper surface is located at a relatively upper position of the display plane, the ESL is disposed on the display plane, and the RF signal transceiver is disposed on the upper surface of the shelf.

5. The ESL system of claim 4, wherein the display plane is intersected with a vertical extension of the upper surface.

6. The ESL system of claim 1, wherein the RF antenna further defines a signal transmitting E-plane, the signal transmitting H-plane is vertically intersected with the signal transmitting E-plane, the RF antenna has a first signal strength on the signal transmitting H-plane and a second signal strength on the signal transmitting E-plane, and the first signal strength is greater than the second signal strength.

7. The ESL system of claim 1, wherein the pre-determined angle is less than 45 degrees.
